(19) United States
(12) Patent Application Publication
(10) Pub. No.: US 2025/0026226 A1
(43) Pub. Date: Jan. 23, 2025

(54) Electric Vehicle Smart Charging For Demand Response Participation For An Electric Grid

(71) Applicant: ABB E-mobility B.V., Delft (NL)

(72) Inventors: Zhenyuan Wang, Apex, NC (US); Kaiyu Liu, Lakewood, CO (US)

(21) Appl. No.: 18/355,026

(22) Filed: Jul. 19, 2023

(51) Int. Cl. B60L 53/63; B60L 53/67; B60L 53/68

(52) U.S. Cl. CPC B60L 53/63; B60L 53/67; B60L 53/68; H02J 3/144

(57) ABSTRACT

In one aspect, a controller for managing a participation of an electric vehicle charging station comprising a plurality of electric vehicle supply equipment in grid support of an electric grid is provided. The controller comprises at least one processor configured to estimate a maximum charging power supplied by the plurality of electric vehicle supply equipment over a time period, identify a demand response request for the electric vehicle charging station to participate in a demand response program for the electric grid during the time period, and generate, based on the estimate and in response to the demand response request, at least one charging profile for one or more of the plurality of electric vehicle supply equipment of the electric vehicle charging station.

### BACKGROUND

The field of the disclosure relates to electric grid support activities, and in particular, to electric vehicle charging stations that provide grid support.

In an electric grid, demand response is used to change the electric power consumption of customers of the electric grid to match the demand for electric power with the supply of electric power. Because the electric grid relies on a balance between electric generation and load, real-time adjustments in the electrical load on the electric grid is used to maintain a stable frequency of the electric grid. As the electrical load on the electric grid is increasing above the amount of electricity being generated, the frequency of the electric grid decreases, which is offset using demand response requests that are used to decrease the electrical load on the electric grid.

Because electric vehicle charging stations impose a significant electrical load on the electrical grid, it would be desirable to provide mechanism for electric vehicle charging stations to participate in demand response requests without adversely impacting ongoing charging activities at the electric vehicle charging stations.

### BRIEF DESCRIPTION

In one aspect, a controller for managing a participation of an electric vehicle charging station comprising a plurality of electric vehicle supply equipment in grid support of an electric grid is provided. The controller comprises at least one communication interface and at least one processor. The at least one processor is configured to estimate a maximum charging power supplied by the plurality of electric vehicle supply equipment over a time period, submit, via the at least on communication interface to at least one management server of the electric grid, the estimate and a request to participate in a demand response program for the electric grid, and identify, via the at least one communication interface, a demand response request from the at least one management server for the electric vehicle charging station to participate in the demand response program during the time period. The at least one processor is further configured to generate, based on the estimate and in response to the demand response request, at least one charging profile for one or more of the plurality of electric vehicle supply equipment of the electric vehicle charging station, and provide, via the at least one communication interface, the at least one charging profile to the one or more of the plurality of electric vehicle supply equipment to implement the demand response request.

In another aspect, a method of managing a participation of an electric vehicle charging station comprising a plurality of electric vehicle supply equipment in grid support of an electric grid is provided. The method comprises estimating a maximum charging power supplied by the plurality of electric vehicle supply equipment over a time period, submitting to at least one management server of the electric grid, the estimate and a request to participate in a demand response program for the electric grid, and identifying a demand response request from the at least one management server for the electric vehicle charging station to participate in the demand response program during the time period. The method further comprises generating, based on the estimate and in response to the demand response request, at least one charging profile for one or more of the plurality of electric vehicle supply equipment of the electric vehicle charging station, and providing the at least one charging profile to the one or more of the plurality of electric vehicle supply equipment to implement the demand response request.

In another aspect, a controller for managing a participation of an electric vehicle charging station comprising a plurality of electric vehicle supply equipment in grid support of an electric grid is provided. The controller comprises at least one processor configured to estimate a maximum charging power supplied by the plurality of electric vehicle supply equipment over a time period, identify a demand response request for the electric vehicle charging station to participate in a demand response program for the electric grid during the time period, and generate, based on the estimate and in response to the demand response request, at least one charging profile for one or more of the plurality of electric vehicle supply equipment of the electric vehicle charging station.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1 depicts a block diagram of a controller for managing a participation of an electric vehicle charging station in grid support of an electric grid in an exemplary embodiment.

FIG. 2 depicts a flow chart of a method of managing a participation of an electric vehicle charging station in grid support of an electric grid in an exemplary embodiment.

FIG. 3 depicts a flow chart of a method of calculating a power budget for charging electric vehicles during demand response events in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

Electric vehicle (EV) charging stations often impart a significant electrical load on the electric grid, which can negatively impact ongoing demand response requests or other types of grid support events being implemented by grid operators. For example, EV charging stations may be increasing their electrical load on the electric grid while grid operators are directing customers to reduce their electrical load, which is contrary to what the grid operators would prefer during such events.

In the present disclosure, various embodiments are disclosed that enable EV charging stations to participate in demand response events by dynamically modifying charging profiles for their electric vehicle supply equipment (EVSE) while maintaining a customer's charging expectations while charging their EVs. For example, some customers may elect to opt-out of demand response events, instead choosing to incur a higher cost for charging during demand response (DR) events. In another example, some customers may elect to participate in DR events at a lower charging rate during DR events, while other customers may elect to participate in DR events by accepting a minimum or zero charge rate during DR events.

In some embodiments, charging profiles are generated during DR events based on a number of secondary factors, which are used to improve the customer's experience while participating in DR events. Such factors may include, for example, charging EVs at a higher rate during DR events when the EVs have been charging longer than other EVs at the EV charging station, which allows EVs that are near the end of their charge to complete charging faster. In like manner, EVs that have been charging a shorter amount of time relative to other EVs at the EV charging station may have their charging profiles modified to charge at a lower rate or zero rate during DR events, as the amount of time typically spent in a DR event is often short as compared to the total time that may be required to charge an EV. These and other features will be described in more detail below.

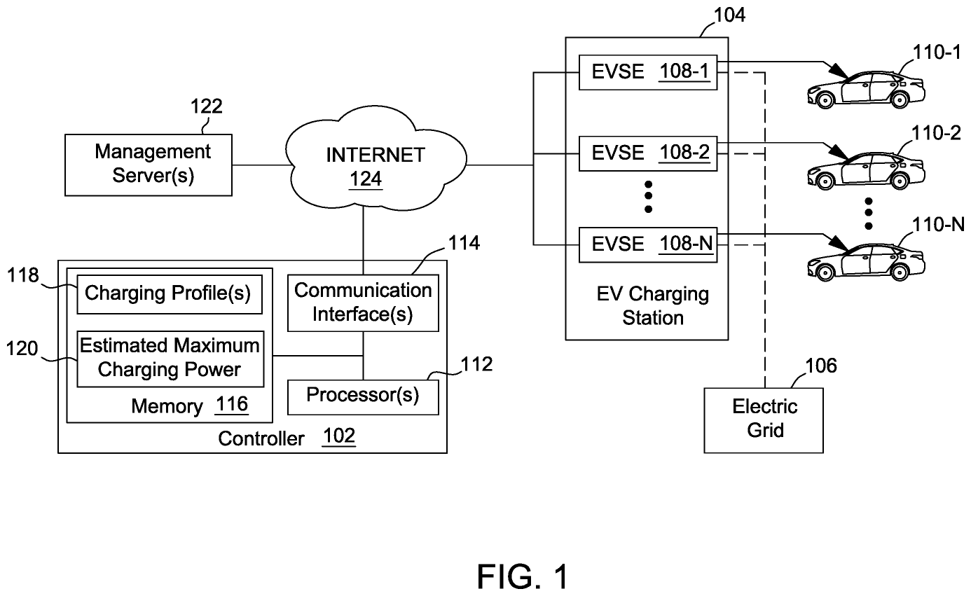

FIG. 1 depicts a block diagram of a controller 102 for managing a participation of an EV charging station 104 in grid support of an electric grid 106 in an exemplary embodiment. In this embodiment, EV charging station 104 comprises a plurality of EVSEs 108, which are used to charge EVs 110. EVSEs 108 are electrically coupled to electric grid 106, and EVSEs 108 are an electrical load on electric grid 106 while charging EVs 110. In this embodiment, EV charging station 104 comprises EVSE 108-1, which charges EV 110-1, EVSE 108-2, which charges EV 110-2, and EVSE 108-N, which charges EV 110-N. Although FIG. 1 depicts EV charging station 104 as including three EVSEs 108, EV charging station 104 may have a different number of EVSEs 108 in other embodiments. Further EVSEs 108 may include multiple charging outlets, such that each EVSE 108 can charge multiple EVs 110.

In the embodiments described herein, controller 102 comprises any component, system, or device that performs the functionality described herein for controller 102. Controller 102 will be described with respect to various discrete elements, which perform functions. These elements may be combined in different embodiments or segmented into different discrete elements in other embodiments. In some embodiments, controller 102 may be partially or fully implemented within a site controller (not shown) of EV charging station 104. In other embodiments, controller 102 may be partially or fully implemented in a cloud compute resource (not shown). In some embodiments, the functionality of controller 102 is partially or fully implemented as a service executing on a computing device (not shown). For example, in some embodiments, the functionality of controller 102 may be partially or fully implemented as a service executing on a computing resource of EV charging station 104 (e.g., a site controller of EV charging station 104).

In this embodiment, controller 102 comprises at least one processor 112, at least one communication interface 114, and at least one memory 116. Memory 116 stores one or more charging profiles 118 and an estimated maximum charging power, referred to herein as estimate 120, for EV charging station 104. Charging profiles 118 define how EVSEs 108 charge their corresponding EVs 110, and estimate 120 is generated by controller 102 based on the an expected amount of electrical power imposed on electric grid by EVSEs 108 over a future time period. For example, estimate 120 may be generated by controller 102 over a time period of the next five minutes.

In some embodiments, controller 102 generates estimate 120 by communicating with EVs 110 (e.g., via EVSEs 108), which provide information to controller 102 regarding the expected future electrical load of EVs 110 on their corresponding EVSEs 108. For example, the charge controllers (not shown) of EVs 110 provide information to controller 102 (via EVSEs 108) of their expected electrical load on EVSEs 108 over the next, for example, five minutes.

In other embodiments, EVSEs 108 measure the current electrical demand of their EVs 110, and controller 102 utilizes the electric demand to generate estimate 120 based on one or more predictive algorithms. For example, controller 102 utilizes the current electric demand measured by EVSEs 108 along with a charging time associated with their EVs 110 to predict the electrical demand over, for example, the next five to ten minutes using a ramp-up profile. In an example of this embodiment, if EV 110-1 is at the beginning of its charge time at EVSE 108-1, then controller 102 may extrapolate that the power supplied by EVSE 108-1 to EV 110-1 is expected to follow a ramp-like power profile over a period of time because EV 110-1 is at the beginning of its charging profile. Estimate 120 is therefore the aggregate estimated power drawn by EVSEs 108 on electric grid 106 over the next x minutes of time, where x may be between about one minute and thirty minutes.

In other embodiments, estimate 120 comprises the maximum amount of charging power supplied by EVSEs 108 to EVs 110 during a charging session. In this embodiment, controller 102 may monitor the power supplied to EVs 110 by EVSEs 108, and record the maximum amount of power measured during a charging session, aggregating the maximum recorded powers in order to generate estimate 120.

Estimate 120 is provided by controller 102 to one or more management servers 122 of electric grid 106 in order to participate in grid support of electric grid 106 via DR requests. Estimate 120 may include various types of information, including the estimated power drawn by EV charging station 104 on electric grid 106, a request to participate in DR events for electric grid 106, and the amount of time the DR participation request is valid for (e.g., the next five minutes).

In this embodiment, controller 102 is communicatively coupled to management server 122 via communication interface 114 and the Internet 124. Communication interface 114 may comprise any wired interface, wireless interface, or combinations thereof, which facilitates the communication of controller 102 with EVSEs 108 and management server 122. Some examples of communication interface 114 includes Wi-Fi interfaces, Ethernet interfaces, cellular network interfaces, etc.

During operation, controller 102 may generate estimate 120 for the immediate future (e.g., the next five minutes) and may transmit estimate 120 along with a DR participation request and/or a DR registration request to management server 122, via communication interface 114 and the Internet 124. If a DR request is identified by controller 102 to participate in grid support (e.g., a request generated by and/or from management server 122 to provide grid support to electric grid 106), then controller 102 may enter into a grid support mode. During grid support mode, controller 102 may generate and/or modify charging profiles 118 (e.g., power limits for EVSEs 108) at time intervals (e.g., every two to four seconds), and may then provide charging profiles 118 to EVSEs 108 to decrease the electric demand of EV charging station 104 on electric grid 106. A decrease in the electric demand of EV charging station 104 on electric grid 106 results in a net power supply injection into electric grid 106 (e.g., which may be used to increase the frequency of electric grid 106).

Generally, a DR request for electric grid 106 comprises a request that EV charging station 104 reduces its electrical load on electric grid 106. In some embodiments, the amount of power reduction, also referred to as a power cut (either as a percentage or an actual amount of electrical power) is decided in advance. For example, the amount of power reduction that EV charging station 104 is willing to accept may be submitted to management server 122 along with estimate 120, and EV charging station 104 may implement the pre-defined power reduction in response to receiving the DR request. In other embodiments, the amount of power reduction is present in the DR request and varies over the DR event and/or between different DR events, and the amount of power reduction implemented by EV charging station 104 varies accordingly. However, participation in DR events may be voluntary, and controller 102 may decide in some cases to opt-out of a DR request for grid support of electric grid 106. For instance, conditions may change such that the amount of power reduction (as either pre-negotiated by controller 102 with management server 122 or included in the DR request from management server 122), cannot be met, such as when additional EVs 110 arrive at EV charging station 104 after estimate 120 is sent to management server 122, and it is not possible to reduce the electric load of EV charging station 104 on electric grid 106 when the DR request is received.

During a DR request, controller 102 generates and/or modifies charging profiles 118 provided to EVSEs 108 based on various criteria in order to promote customer participation in DR events at EV charging station 104. One criteria includes maximizing the charging rate at EVs 110 during DR events based on priorities and/or DR opt-outs by customers. In one embodiment, the customer for EV 110-1 may opt-out of DR events altogether, and instead elect to pay more for electricity during the charging session and/or during the DR event. In another embodiment, the customer for EV 110-1 may partially opt-out of DR events, and elect to accept a reduced charging power during DR events. In some embodiments, the customer may elect some combination of increased costs and/or reduced charging power in order to participate in the DR events.

In some embodiments, controller 102 generates charging profiles 118 to maximize the charging rates of EVs 110 when certain conditions occur. For example, if EV 110-1 has been charging longer than either EV 110-2 or EV 110-N, then charging profile 118 for EVSE 108-1 may be generated by controller 102 to maximize the charging rate of EV 110-1, with EVs 110-2, 110-N being charged at a lower rate than EV 110-1. This improves the customer's DR experience by allowing EVs 110 that are closer to their end of charging time to complete faster. In some embodiments, the lower rate of charging follows a decreasing or increasing value that varies based on the amount of time the charging session has been active (with the exception of EV 110 that has the highest charging time).

In some embodiments, charging profiles 118 are generated by controller 102 during DR requests based on a selection by a customer of EVs 110. For example, as discussed above, a customer may elect to opt-out of participating in DR events, partially opt-out of participating in DR events, and/or may select a pre-defined power reduction for participating in DR events (e.g., the customer may select to accept a pre-defined percentage reduction in the charging power in order to participate in DR events).

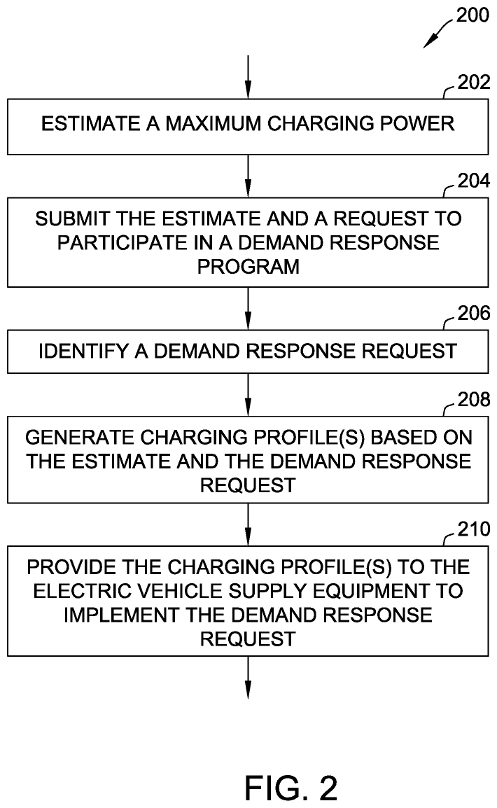

FIG. 2 depicts a flow chart of a method 200 of managing a participation of a charging station comprising a plurality of EVSEs in grid support of an electric grid in an exemplary embodiment. Method 200 will be discussed with respect to controller 102 and FIG. 1. However, method 200 may be performed by other systems, not shown.

In this embodiment, method 200 comprises estimating 202 a maximum charging power supplied by the EVSEs over a time period. In one example, processor 112 communicates with EVs 110 using communication interface 114 and Internet 124 (e.g., via EVSEs 108) in order to generate estimate 120 over the time period. In this example, processor 112 may communicate with EV 110-1 in order to determine what the expected charging rate and/or charging power of EVSE 108-1 will be over the time period, which is aggregated with the remaining EVSEs 108-2, 108-N in order to generate estimate 120. In another example, processor 112 communicates with EVSEs 108 and requests that EVSEs 108 provide their current electrical demand in order to generate estimate 120 over the time period based on a predictive model. In this example, processor 112 may communicate with EVSE 108-1 in order to determine what the current charging rate and/or charging power of EVSE 108-1 is, and apply a predictive model over the time period, which is aggregated with the remaining EVSEs 108-2, 108-N in order to generate estimate 120. In some cases, the predictive model includes a ramp-up period. For instance, if EV 110-1 is at the beginning of its charging session, then processor 112 may utilize the current charging rate and/or charging power at EVSE 108 and apply a ramp-up function over a period of time in order to determine the portion of electrical load contribution of EVSE 108-1 to estimate 120. In other embodiments, processor 112 communicates with EVSEs 108 and requests that EVSEs 108 provide their current electrical demand over time to identify the maximum amount of power delivered to EVs 110 during a charging session, which is used by processor 112 to generate estimate 120.

Method 200 further comprises submitting 204 to at least one management server of the electric grid, the estimate and a request to participate in a DR response program for the electric grid. For example, processor 112 submits estimate 120 and the DR participation request to management server 122 via communication interface 114 and Internet 124.

Method 200 further comprises identifying 206 a DR request from the at least one management server to participate in the DR response program for the electric grid. The DR request may include or represent a request to reduce the estimated maximum charging power by a pre-defined amount or a pre-defined percentage. For example, processor 112 polls and/or receives a push notification from management server 122 (e.g., via communication interface 114 and Internet 124) requesting that EV charging station 104 participate in a DR response for electric grid 106.

Method 200 further comprises generating 208, based on the estimate and in response to the DR request, at least one charging profile for one or more of the EVSEs of the electric vehicle charging station. For example, processor 112 generates one or more charging profiles 118 based on estimate 120 and the DR request to reduce the electrical load of EV charging station 104 on electric grid 106. In some embodiments, generating charging profiles 118 is based on a charging time of EVs 110. For example, charging profiles 118 are generated to maximize the charging rate of EVs 110 that have the highest or longest charging time, in order to ensure that those EVs 110 complete their charging faster. In other embodiments, charging profiles 118 are generated based on selections from a customer of EVs 110. For instance, a customer may opt-out of DR events, partially opt-out of DR events, and/or select a pre-defined charging rate during DR events as discussed above.

Method 200 further comprises providing 210 the at least one charging profile to the one or more EVSEs to implement the DR request. For example, processor 112 provides charging profiles 118 to EVSEs 108 (e.g., via communication interface 114 and Internet 124) to implement the DR request.

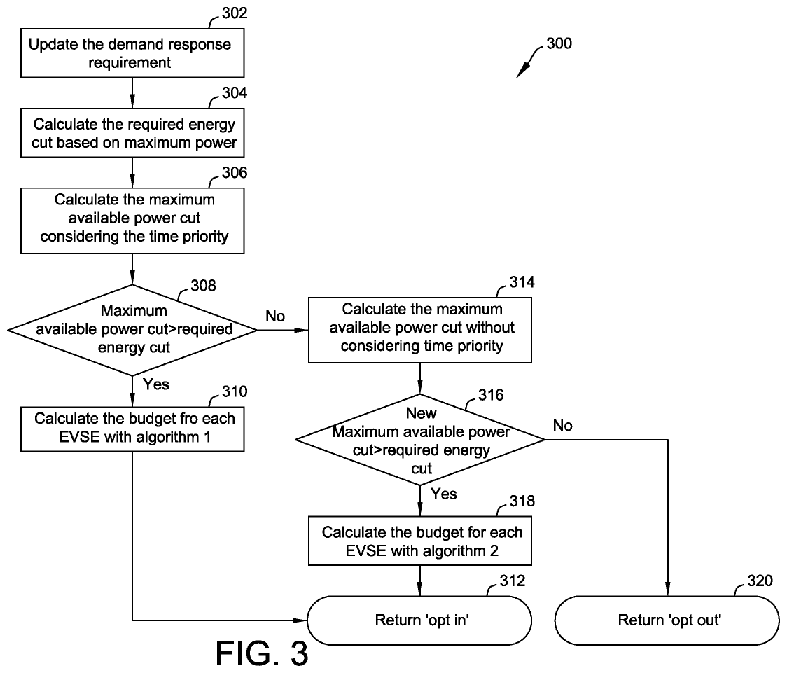

FIG. 3 depicts a flow chart of a method 300 of calculating a power budget for charging EVs during DR events in an exemplary embodiment. Method 300 will be discussed with respect to controller 102 and FIG. 1. However, method 300 may be performed by other systems, not shown. Method 300 may be performed in response to receiving a DR request and/or in response to a new or ending charging sessions for EVs 110. Generally, the goal of the power budget illustrated in FIG. 3 is to attempt to accommodate the customer's options for DR participation with respect to charging. In this embodiment of the power budget, the three options provided to the customer with respect to DR participation include: always charge at full power with premium pricing during DR events, referred to as charge mode one; charge at a reduced power up to 50% of the maximum power encountered in the charging session during DR events, referred to as charge mode two, and deferring the charging session during DR events with the lowest charging cost, referred to as charge mode 3.

In this embodiment, the goal of the power budget depicted in method 300 includes (1) maintaining the minimum charging rate based on the charge mode selected by the user, (2) obtaining the load reduction requirement set by the DR request, and (3) prioritizing the charging of EVs 110 that have been charging for longer than other EVs 110. Generally, these goals are listed based on priority, such that goal (1) should be met prior to considering goal (2), and goal (2) should be met prior to considering goal (3).

Assuming that there are K active charging profiles 118, each corresponding to an EVSE 108 or a charging outlet at an EVSE 108, if there is more than one outlet, then the maximum energy consumption of EV charging station 104 is the sum of the maximum power recorded at every active charging outlet during their charging sessions:

$${P}_{max , Station} = {\sum }_{k = 1}^{K} {P}_{max , k} * bReachedPmax , k . \qquad eq . 1$$

where P_{max,Station} is the total charging power of EV charging station 104, P_{max,k} is the maximum charging power recorded in the kth charging profile, and bReachedPmax,k is a Boolean variable of whether the maximum charging power has been measured for the kth charging profile (see block 302 of FIG. 1).

Next, the energy reduction requested by management server 122 is calculated in block 304:

$${P}_{CutReq} = {DR}_{req} * {P}_{max , Station} . \qquad eq . 2$$

Where P_{CutReq} is the requested power reduction, and, DR_{req} is the requested power reduction percentage according to the received DR request.

The total requested power curtailment is assigned to each outlet of EVSEs 108 according to a number of factors, such as the maximum charging power of EVs 110, the minimum charging rate selected by the owners of the EVs 110, the amount of time that EVs 110 have been charging, etc. In this embodiment, there are three charging operational modes: in mode (a), the load reduction request can be met while EV 110 with the longest charging time is given full priority in the algorithm; in mode (b), the load reduction request can be met while EV 110 with the longest charging time is given partial priority in the algorithm; and in mode (c), the energy reduction requested is larger than the maximum available power reduction available at EV charging station 104, and EVs 110 will charge at a minimum charging rate. The available power reduction of EV charging station 104 in mode (a) is computed considering the charging time of each charging session. The available power reduction of each outlet at EVSEs 108 decreases with charging time in a linear manner with a time constant T. Rateₐ is the percentage of maximum charging power that is available for reduction in mode (a) (see block 306):

$${P}_{CutAvail 1 , k} = {P}_{max , k} * {Rate}_{a , k} * bReachedPmax . \qquad eq . 3$$

$${Rate}_{a} = \{ \begin{matrix}0 , Charge mode = 1 \\ 0.5 - \frac{t - {t}_{start}}{T} , Charge mode = 2 and t - {t}_{start} \leq T / 2 \\ 0 , Charge mode = 2 and t - {t}_{start} > T / 2 \\ 1. - \frac{t - {t}_{start}}{T} , Charge mode = 3 and t - {t}_{start} \leq T \\ 0 , Charge mode = 3 and t - {t}_{start} > T\end{matrix} \\ {P}_{CutAvail 1} = {\sum }_{k = 1}^{K} {P}_{CutAvail 1 , k} . \qquad eq . 4$$

If P_{CutAvail1}≥P_{CutReq}, (see block 308) then the requirements of giving more charging priority to EV 110 that has been charging for longer can be met, and the power budget for each outlet is computed as (see block 310):

$${P}_{budget , k} = {P}_{max , k} - \frac{{P}_{CutReq}}{{P}_{CutAvail 1}} * {P}_{CutAvail 1 , k} . \qquad eq . 5$$

If P_{CutAvail1}<P_{CutReq}, then this means that the total available power reduction in mode (a) cannot meet the power reduction of the DR request. Therefore, additional power reductions are needed beyond mode (a) to meet the power reduction of the DR request. That is, additional power reductions are needed, which are made in mode (b) by cutting a portion of the energy to EVs 110 that follow a decreasing charging rate based on their charging time. The available power reduction at EV charging station 104 in mode (b) is the power decreased with charging time in mode (a). Therefore, the total available power in mode (a) and mode (b) sum up to the maximum power cut of each outlet of EVSEs 108, according to the minimum charging rate set by the customers. Rate_{b} is the percentage of the maximum charging power that is available to cut in mode (b) (see block 314):

$${P}_{CutAvail 2 , k} = {P}_{max , k} * {Rate}_{b , k} * bReachedMax . \qquad eq . 6$$

$${Rate}_{b} = \{ \begin{matrix}0 , Charge mode = 1 \\ \frac{t - {t}_{start}}{T} , Charge mode = 2 and t - {t}_{start} \leq T / 2 \\ 0.5 , Charge mode = 2 and t - {t}_{start} > \frac{T}{2} \\ \frac{t - {t}_{start}}{T} , Charge mode = 3 and t - {t}_{start} \leq T \\ 1. , Charge mode = 3 and t - {t}_{start} > T\end{matrix} \\ {P}_{CutAvail 2} = {\sum }_{k = 1}^{K} {P}_{CutAvail 2 , k} . \qquad eq . 7$$

If P_{CutAvail1}+P_{CutAvail2}≥P_{CutReq}, P_{CutAvail1}<P_{CutReq}, (see block 316) then the requirement of providing more charging priority to EV 110 that has been charging the longest is still partially taken into consideration while still managing to cut the requested amount of power from the DR request. In mode (b), the power budget of each outlet at EVSEs 108 is calculated as (see block 318):

$${P}_{CutReqRest} = {P}_{CutReq} - {P}_{CutAvail 1} . \qquad eq . 8$$

$${P}_{budget , k} = {P}_{max , k} - {P}_{CutAvail 1 , k} - \frac{{P}_{CutReqRest} * {P}_{CutAvail 2 , k}}{{P}_{CutAvail 2}} . \qquad eq . 9$$

In both mode (a) and mode (b), the power cut of the DR request is met and controller 102 can return an “opt-in” message (see block 312) for the DR request.

If P_{CutAvail1}+P_{CutAvail2}<P_{CutReq}, (see block 316) then controller 102 will operate in mode (c). The requested power cut cannot be met even if the maximum power available to EV charging station 104. EVs 110 will charge at their minimum charging rate set by the customers. In this case, controller 102 returns an “opt-out” message (see block 320) to management server 122 indicating that EV charging station 104 will not participate in the DR request.

An example technical effect of the embodiments described herein includes at least one of: (a) facilitating the ability of EV charging stations to participate in grid support using an automated EV charging demand response function with real-time or near real-time communications with a grid operator; (b) EV charging stations can operate as an aggregate load on the electric grid in order to provide a large controllable load for the electric grid operator; and (c) the coordination between charging EVs and maintaining a minimum charging rate selected by customers for their EVs along with considering the time an EV has been charging improves the charging experience for the customer, thereby promoting the customer to participate in DR events.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for managing a participation of an electric vehicle charging station comprising a plurality of electric vehicle supply equipment in grid support of an electric grid, the controller comprising:
at least one communication interface;
at least one processor configured to:
estimate a maximum charging power supplied by the plurality of electric vehicle supply equipment over a time period;
submit, via the at least one communication interface to at least one management server of the electric grid, the estimate and a request to participate in a demand response program for the electric grid;
identify, via the at least one communication interface, a demand response request from the at least one management server for the electric vehicle charging station to participate in the demand response program during the time period;
generate, based on the estimate and in response to the demand response request, at least one charging profile for one or more of the plurality of electric vehicle supply equipment of the electric vehicle charging station; and
provide, via the at least one communication interface, the at least one charging profile to the one or more of the plurality of electric vehicle supply equipment to implement the demand response request.

2. The controller of claim 1, wherein a charging profile of the at least one charging profile is generated based on a charging time of an electric vehicle charged according to the charging profile.

3. The controller of claim 2, wherein the charging profile maximizes a charging rate of the electric vehicle in response to the electric vehicle having a longest charging time with respect to other electric vehicles being charged at the electric vehicle charging station.

4. The controller of claim 1, wherein a charging profile of the at least one charging profile is generated based on a selection by a customer of an electric vehicle charged according to the charging profile for participating in demand response events.

5. The controller of claim 1, wherein the at least one processor is further configured to:
estimate the maximum charging power by communicating with one or more electric vehicles charged by one or more of the plurality of electric vehicle supply equipment.

6. The controller of claim 1, wherein the at least one processor is further configured to:
estimate the maximum charging power based on a ramp-up period after charging begins at one or more of the plurality of electric vehicle supply equipment.

7. The controller of claim 1, wherein:
the demand response request comprises a request to reduce the estimated maximum charging power by a pre-defined amount.

8. The controller of claim 1, wherein:
the demand response request comprises a request to reduce the estimated maximum charging power by a pre-defined percentage.

9. A method of managing a participation of an electric vehicle charging station comprising a plurality of electric vehicle supply equipment in grid support of an electric grid, the method comprising:
estimating a maximum charging power supplied by the plurality of electric vehicle supply equipment over a time period;
submitting to at least one management server of the electric grid, the estimate and a request to participate in a demand response program for the electric grid;
identifying a demand response request from the at least one management server for the electric vehicle charging station to participate in the demand response program during the time period;
generating, based on the estimate and in response to the demand response request, at least one charging profile for one or more of the plurality of electric vehicle supply equipment of the electric vehicle charging station; and
providing the at least one charging profile to the one or more of the plurality of electric vehicle supply equipment to implement the demand response request.

10. The method of claim 9, wherein generating the at least one charging profile further comprises:
generating a charging profile of the at least one charging profile based on a charging time of an electric vehicle charged according to the charging profile.

11. The method of claim 10, wherein generating the at least one charging profile further comprises:
generating the charging profile to maximize a charging rate of the electric vehicle in response to the electric vehicle having a longest charging time with respect to other electric vehicles being charged at the electric vehicle charging station.

12. The method of claim 9, wherein generating the at least one charging profile further comprises:
generating a charging profile of the at least one charging profile based on a selection by a customer of an electric vehicle charged according to the charging profile for participating in demand response events.

13. The method of claim 9, wherein estimating the maximum charging power further comprises:
estimating the maximum charging power by communicating with one or more electric vehicles charged by one or more of the plurality of electric vehicle supply equipment.

14. The method of claim 9, wherein estimating the maximum charging power further comprises:
estimating the maximum charging power based on a ramp-up period after charging begins at one or more of the plurality of electric vehicle supply equipment.

15. The method of claim 9, wherein:
the demand response request comprises a request to reduce the estimated maximum charging power by a pre-defined amount.

16. The method of claim 9, wherein:
the demand response request comprises a request to reduce the estimated maximum charging power by a pre-defined percentage.

17. A controller for managing a participation of an electric vehicle charging station comprising a plurality of electric vehicle supply equipment in grid support of an electric grid, the controller comprising at least one processor configured to:
estimate a maximum charging power supplied by the plurality of electric vehicle supply equipment over a time period;
identify a demand response request for the electric vehicle charging station to participate in a demand response program for the electric grid during the time period; and
generate, based on the estimate and in response to the demand response request, at least one charging profile for one or more of the plurality of electric vehicle supply equipment of the electric vehicle charging station.

18. The controller of claim 17, wherein the at least one processor is further configured to:
provide the at least one charging profile to the one or more of the plurality of electric vehicle supply equipment to implement the demand response request.

19. The controller of claim 17, wherein the at least one processor is further configured to:
estimate the maximum charging power based on a ramp-up period after charging begins at one or more of the plurality of electric vehicle supply equipment.

20. The controller of claim 17, wherein:
a charging profile of the at least one charging profile is generated based on a charging time of an electric vehicle charged according to the charging profile; and
the charging profile maximizes a charging rate of the electric vehicle in response to the electric vehicle having a longest charging time with respect to other electric vehicles being charged at the electric vehicle charging station.
